(19) United States
(12) Patent Application Publication
(10) Pub. No.: US 2016/0227809 A1
(43) Pub. Date: Aug. 11, 2016

(54) MITIGATION OF 2-MCPD, 3-MCPD, ESTERS THEREOF AND GLYCIDYL ESTERS IN VEGETABLE OIL

(71) Applicant: AAK AB, Malmo (SE)

(72) Inventor: Jens Mellerup, Tilst (DK)

(21) Appl. No.: 15/029,273

(22) PCT Filed: Oct. 13, 2014
(86) PCT No.: PCT/SE2014/051206

§ 371 Date: Apr. 14, 2016

(30) Foreign Application Priority Data
Oct. 14, 2013 (SE) 1351217-3

(51) Int. Cl. A23D 9/04; C11B 3/06; C11B 3/02; C11B 3/00; C11B 3/12

(52) U.S. Cl. CPC A23D 9/04; A23L 1/3006; C11B 3/001; C11B 3/12; C11B 3/02; C11B 3/06; C11B 3/006; A23V 2002/00

(57) ABSTRACT

The present invention relates to a process for the mitigation of 2-MCPD, 3-MCPD, esters thereof and glycidyl esters in vegetable oil comprising the steps of a) subjecting the vegetable oil to one or more refining steps and b) subjecting the refined vegetable oil from step a) to a vacuum distillation at about 200-280° C. and at pressure of about 0.0001-3.0 mbar.

### TECHNICAL FIELD

The present invention relates to the field of vegetable fats and oils. More particularly, the invention relates to a process for reducing the amount of 3-monochloropropane-1,2-diol (3-MCPD), 2-monochloropropane-1,3-diol (2-MCPD) and esters thereof as well as reducing the amount of glycidyl esters in refined vegetable oil.

### BACKGROUND

It is known that 3-chloro-1,2-propanediol (3-MCPD) and 2-chloro-1,3-propanediol (2-MCPD) are formed in processed fats for foodstuff. Typically, these compounds are found as esters of fatty acids in triglyceride fats and oils at various concentrations, depending on the oil source, refining steps and other factors.

Also, glycidol and fatty acid esters thereof may be present in refined triglyceride fats and oils.

2-MCPD, 3-MCPD and glycidol compounds are not desirable in foodstuff due to potential hazards related to their intake. Knowledge about the exact mechanisms of the formation of these compounds during the processing of edible oils is limited. Attempts to reduce the formation of such compounds during the processing of edible oils have been made, but are met by little success so far.

Matthäus and Pudel et al. (Lipid Technology, Vol. 25, No 7, pg 151-155, 2013) summarizes the most promising way of mitigation as to prevent the formation of the compounds or its precursors.

WO2011/069028 describes methods for removing glycidyl esters from an oil wherein said methods comprises contacting the oil with an adsorbent, contacting the oil with an enzyme or deodorizing the oil at a temperature no greater than 240 degrees C., deodorizing the oil with at least one sparge, contacting the oil with a solution comprising an acid, or re-bleaching the oil

WO2012/107230 describes a method for the production of a refined oil having reduced 3-MCPD ester and/or glycidyl ester content characterized in that it comprises re-bleaching and re-deodorizing the oil, wherein the final deodorization is carried out at a temperature at least 40° C. lower than the previous deodorization step(s).

Thus, there remains a need to reduce the concentrations of 2-MCPD, 3-MCPD and glycidyl esters in triglyceride oils for foodstuff. The present invention addresses such needs and interests.

### SUMMARY

In one aspect, the present invention relates to a process for the mitigation of 2-MCPD, 3-MCPD, esters thereof and glycidyl esters in vegetable oil, said process comprises the steps of

a) subjecting vegetable oil to one or more refining steps and
b) subjecting the refined vegetable oil from step a) to a vacuum distillation at about 200-280° C. and at a pressure of about 0.001-3.0 mbar.

Further embodiments of said process are wherein the refining steps of step a) comprise at least one of de-gumming, bleaching, deacidification and deodorizing.

Still further embodiments of said process are wherein the vacuum distillation is performed at a temperature of between about 220-270° C., such as between about 230-260° C.

Still further embodiments of said process are wherein the vacuum distillation is performed at a pressure of 0.002-2.5 mbar, preferably at a pressure of 0.005-2.0 mbar, or even at a pressure of 0.005-1.5 mbar.

Still even further embodiments of said process are wherein the amount of 2-MCPD and/or 3-MCPD is reduced by at least 30% by weight, such as at least 60% by weight, at least 70% by weight, or even at least 80% by weight, or such as at least 90% by weight, at least 95% by weight, at least 98% by weight, or at least 99 or even 99.9% by weight, after step b) when compared to the amount of 2-MCPD and/or 3-MCPD present in the vegetable oil after step a).

Still even further embodiments of said are wherein the amount of glycidyl esters is reduced by at least 30% by weight, such as at least 80% by weight, such as at least 90% by weight, such as at least 95% by weight, such as at least 98% by weight, such as at least 99 or even such as 99.9% by weight after step b) when compared to the amount of glycidyl esters present in the vegetable oil after step a).

Still even further embodiments of said process are wherein the vegetable oil is selected from the group consisting of coconut oil, palm kernel oil, sunflower oil, soybean oil, rapeseed oil, palm oil, olive oil, avocado oil, corn oil, ground nut oil, shea oil, cocoa butter, safflower oil, sal oil, and illippe oil.

Still even further embodiments of said process are, wherein step a) comprises deodorization at a temperature between 180 and 270° C. and a pressure between 0.5-8 mbar.

Still even further embodiments of said process are wherein said vacuum distillation is a molecular distillation such as short path distillation (SPD).

Still even further embodiments of said process according are, wherein the refining steps according to step a) produce 3-MCPD and/or glycidyl esters within the vegetable oil, and the combined concentration of 3-MCPD and glycidyl esters is at least 1 mg/kg.

Still even further embodiments of said process are, wherein the vacuum distillation process of step b) is a short path distillation and the residence time of the oil in step b) is below 10 minutes, preferably below 5 minutes, more preferably below 3 minutes.

One further aspect of the present invention relates to a vegetable oil treated by the process as described herein according to any of its embodiments.

Still one further aspect relates to use of said vegetable oil or the vegetable oil treated by the process as described herein according to any of its embodiments, in an edible food product.

Further embodiments of said use according to any of its embodiments are wherein said edible food product is a nutrition product, such as an infant nutrition product, a toddler nutrition product, or an elderly nutrition product.

Still one further aspect relates to an edible food product comprising said vegetable oil of according to any of its embodiments, or the vegetable oil treated by the process according to any of its embodiments.

Further embodiments of the edible food product are wherein said food product is a nutrition product, an infant nutrition product, a toddler nutrition product, or an elderly nutrition product.

### SHORT DESCRIPTION OF DRAWINGS

FIG. 1 shows a schematic diagram of the process according to the first aspect of the invention.

### DETAILED DESCRIPTION

### Definitions

As used herein the term “MCPD-compounds” refers to the group of chemicals consisting of 2-MCPD and esters thereof, 3-MCPD and esters thereof, glycidol and glycidyl esters.

As used herein, the term “fatty acid” encompasses fatty acid residues in triglycerides.

As used herein “edible” is something that is suitable for use as food or as part of a food product. An edible fat is thus suitable for use as fat in food or food product and an edible composition is a composition suitable for use in food or a food product.

As used herein, “%” or “percentage” all relates to weight percentage i.e. wt % or wt-% if nothing else is indicated.

As used herein, the singular forms “a”, “and” and “the” include plural referents unless the context clearly dictates otherwise.

As used herein, “at least one” is intended to mean one or more, i.e. 1, 2, 3, 4, 5, 6, 7, 8, 9, 10, etc.

As revealed above, the present invention relates to mitigation of 2-MCPD, 3-MCPD, esters of both thereof, glycidol and glycidyl esters.

The origin of 2-MCPD, 3-MCPD, esters thereof and glycidyl ester compounds in vegetable oil is not entirely clear but possible health issues relate to their presence in edible vegetable oils deserves attention. It is believed that most 2-MCPD, 3-MCPD, esters thereof and glycidyl ester compounds are formed at elevated temperatures during refining steps such as de-gumming and deodorization from substances naturally present in the oils.

Taking deodorization as one of the critical steps with respect to 2-MCPD, 3-MCPD, esters thereof and glycidyl ester compound formation, it seems logical to alter the deodorization for minimizing the tendency to produce 2-MCPD, 3-MCPD, esters thereof and glycidyl ester compounds. Evidently such attempts have not been very successful although a lot of effort has been put into research concerning mechanisms for the formation of 2-MCPD, 3-MCPD, esters thereof and glycidyl ester compounds and parameters in the deodorization having a high impact on the formation of 2-MCPD, 3-MCPD, esters thereof and glycidyl ester compounds.

The same is true for other refining steps.

The present invention provides a simple and effective way to address these health issues by providing a process that can significantly reduce or practically more or less completely remove 2-MCPD, 3-MCPD, esters thereof and glycidyl ester compounds, the inventive process depending less on the conditions used in the refining steps.

It has surprisingly been shown that after refining, 2-MCPD, 3-MCPD, esters thereof and glycidyl ester compounds can be effectively reduced in concentration in vegetable oil by subjecting the refined oil to a vacuum distillation process. The conditions during the vacuum distillation are believed not to produce 2-MCPD, 3-MCPD, esters thereof and glycidyl ester compounds in measurable amounts but instead to transfer these compounds to the distillate together with small amounts of the vegetable oil and remaining impurities after refining.

Surprisingly it has been found that the amounts of 2-MCPD, 3-MCPD, esters thereof and glycidyl ester compounds present in the vegetable oil prior to vacuum distillation correlate very well with the amounts found in the distillate and those remaining in the vegetable oil after vacuum distillation. This confirms that the conditions during vacuum distillation according to embodiments of the present invention do not produce further 2-MCPD, 3-MCPD, esters thereof and glycidyl ester compounds, contrary to expectations

Accordingly, in a first aspect the present invention relates to a process for the mitigation of 2-MCPD, 3-MCPD, esters thereof and glycidyl esters in vegetable oil, said process comprises the steps of

a) subjecting the vegetable oil to one or more refining steps and
b) subjecting the refined vegetable oil from step a) to a vacuum distillation at about 200-280° C. and at a pressure of about 0.001-3.0 mbar.

In further embodiments of the invention the vacuum distillation is performed at a pressure of 0.002-2.5 mbar, such as at a pressure of 0.005-2.0 mbar, or even at a pressure of 0.005-1.5 mbar.

According to the first aspect of the invention it has been found that 2-MCPD, 3-MCPD, esters thereof and glycidyl ester compounds can be substantially reduced in refined vegetable oil by subjecting the oil to high temperature and low pressure such as a vacuum distillation.

In this way the whole chain of refining steps do not need optimization towards low 2-MCPD, 3-MCPD, esters thereof and glycidyl ester compounds formation. Attempts to reduce MCPD- and glycidyl ester compounds during refining will inevitably reduce yield. The present invention will not reduce yields, but instead give a very high yield. For example, vacuum distillation will only waste minimum amounts of oil, and, more importantly, it will not alter the triglyceride composition in any significant way. The authenticity of the oil is therefore largely or fully preserved.

The higher yield is a consequence of being able to run the refining optimized towards yield and desired quality, without being bound by certain procedures to minimize the formation of glycidol, 2-MCPD, 3-MCPD, esters thereof, i.e. as used herein meaning esters of both 2-MCPD, 3-MCPD, and glycidyl ester compounds. Furthermore, the vacuum distillation for reduction of MCPD-compounds after refining is highly efficient with respect to removal of 2-MCPD, 3-MCPD, esters thereof and glycidyl ester compounds, while only minute amounts of valuable oil are lost in this process.

The low pressure applied reduces the boiling point of the oil components, including 2-MCPD, 3-MCPD, esters thereof and glycidyl ester compounds.

In an embodiment of the invention the refining steps of step a) comprise at least one of de-gumming, bleaching, deacidification and deodorizing.

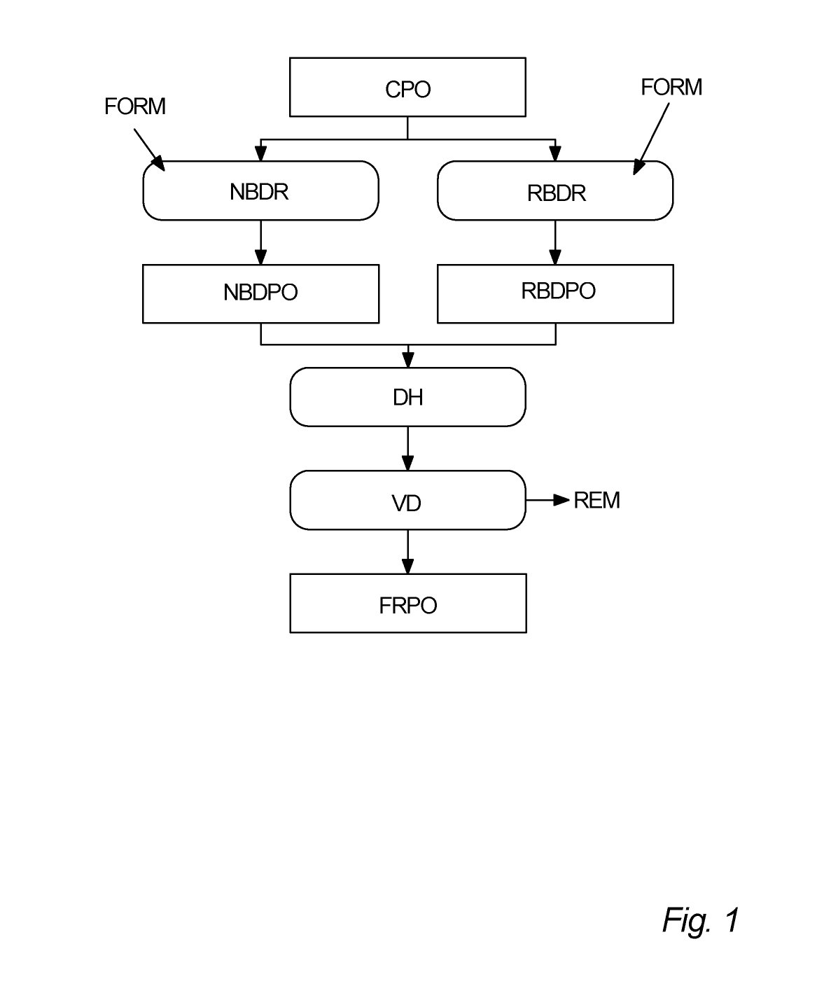

Referring to FIG. 1, a process according to an embodiment of the invention is illustrated. First, a portion of crude palm oil (CPO) is subjected to NBD refining (NBDR), i.e. neutralization, bleaching, and deodorization, to form a NBD palm oil (NBDPO), or subjected to RBD refining (RBDR), i.e., bleaching, refining, and deodorization, to form a RBD palm oil (RBDPO). During the NBD refining (NBDR) and RBD refining (RBDR), formation of MCPD and/or glycidol compounds (FORM) may typically occur. The obtained NBD palm oil (NBDPO) and/or RBD palm oil (RBDPO) is then subjected to a degassing and heating step (DH), then to a vacuum distillation (VD). From the vacuum distillation (VD) a fully refined palm oil (FRPO) is obtained while a removal of MPCD and glycidol compounds (REM) occurs. Due to the removal of MCPD and glycidol compounds (REM), the fully refined palm oil (FRPO) will have mitigated levels of such MCPD and glycidol compounds.

2-MCPD, 3-MCPD, esters thereof and glycidyl ester compounds may be formed during several refining processes. 2-MCPD, 3-MCPD, esters thereof and glycidyl ester compounds are formed in various amounts, depending primarily on type of oil, temperatures and process times of the various refining steps. Because the exact mechanisms of the formation of 2-MCPD, 3-MCPD, esters thereof and glycidyl ester compounds are not fully known, the attempts to optimize refining with respect to formation of 2-MCPD, 3-MCPD, esters thereof and glycidyl ester compounds have been partly based on a trial and error approach which of course is very demanding and not always reliable.

In an embodiment of the invention the vegetable oil is subjected to at least one refining step prior to the vacuum distillation, the at least one refining step being run at a temperature equal to or greater than about 230° C.

In an embodiment of the invention the at least one refining step is a deodorization process.

In an embodiment of the invention the vegetable oil is subjected to a deodorization process at a temperature between about 180 and 270° C. prior to a vacuum distillation.

In an embodiment of the invention the vegetable oil is subjected to a deodorization process at a temperature between 230 and 270° C. prior to by a vacuum distillation at a temperature between 200-280° C. and a pressure of 0.001-3.0 mbar.

In an embodiment of the invention the vegetable oil is subjected to at least one refining step prior to the vacuum distillation, the at least one refining step being run at a temperature equal to or greater than about 230° C., the vacuum distillation following directly after the refining step being run at a temperature equal to or greater than about 230° C.

In an embodiment of the invention the vacuum distillation is a short path distillation.

In a further embodiment of the invention, the vegetable oil is subjected to at least one refining step prior to the vacuum distillation, wherein said at least one refining step is run at a temperature equal to or greater than 230° C., for example a deodorization step run at a temperature equal to or greater than 230° C., and wherein said vacuum distillation is a short path distillation.

According to the invention the refining steps prior to vacuum distillation may be optimized to obtain the desired quality of oil and need not necessarily to be tuned with respect to their tendency to form 2-MCPD, 3-MCPD, esters thereof and glycidyl ester compounds.

The demand for good quality vegetable oil is high and refining native oils and oil blends is necessary to provide odorless and stable products having little colour and good shelf life.

These products may be used in various food applications targeting specific sub-populations with specific nutritional needs such as infants, toddlers and elderly. Examples are nutrition products, such as an infant nutrition product, a toddler nutrition product or an elderly nutrition product. Other food applications are margarine and similar products, bread and rolls, fine bakery wares as well as preserved meat, e.g. smoked meat.

A drawback of the refining is the formation of 2-MCPD, 3-MCPD, esters thereof and glycidyl ester compounds. This may not be tolerable in certain kinds of food products, especially in food for infants.

According to embodiments of the invention the vacuum distillation step of the present process will remove a large percentage of the 2-MCPD, 3-MCPD, esters thereof and glycidyl ester compounds in the oil and an optimization of preceding process steps becomes more or less obsolete.

In an embodiment of the invention the vacuum distillation is performed at a temperature of between about 220-270° C., such as between about 230-260° C.

The temperature during the vacuum distillation is selected to balance efficiency of 2-MCPD, 3-MCPD, esters thereof and glycidyl ester compound removal, process time, pressure and equipment design. At lower pressures, for example below 0.5 mbar, a lower distillation temperature, for example 225° C., may be used, while at somewhat higher pressure, for example 1.5 mbar, a higher distillation temperature of for example 265° C. may be preferred.

By combining low pressure and high temperatures, a very efficient removal of 2-MCPD, 3-MCPD, esters thereof and glycidyl ester compounds may be obtained.

The pressure during the vacuum distillation following the refining is one of the decisive parameters with respect to 2-MCPD, 3-MCPD, esters thereof and glycidyl ester compound removal. At very low pressures, for example below 0.05 mbar, the distillation process at about 260° C. may remove approximately 90% of the 2-MCPD, 3-MCPD, esters thereof and glycidyl ester compounds, while at even lower pressures, such as 0.005 mbar, the removal may be more or less complete. At pressures around 0.1 mbar, still a reduction of 50% or more is possible.

The pressure during the vacuum distillation process may be adjusted according to equipment used and pump capacity available. According to embodiments of the invention, a pressure of for example 1.0 mbar will be sufficiently low to obtain a desired removal of 2-MCPD, 3-MCPD, esters thereof and glycidyl ester compounds at a temperature of for example 260° C.

Reducing the pressure to for example 0.1 mbar and keeping the temperature at 260° C. may remove a higher percentage of 2-MCPD, 3-MCPD, esters thereof and glycidyl ester compounds, while keeping other things equal.

Any reduction in the concentration of 2-MCPD, 3-MCPD, esters thereof and glycidyl ester compounds in edible vegetable oils is of course interesting and may help create healthier and more valuable products. Accordingly, the present invention provides a process that may be capable of a substantially complete removal of 2-MCPD, 3-MCPD, esters thereof and glycidyl ester compounds from refined vegetable oil in certain embodiments, but may, in other embodiments be more economically configured to significantly reduce the concentration of 2-MCPD, 3-MCPD, esters thereof and glycidyl ester compounds in the refined vegetable oil.

In an embodiment of the invention the amount of 2-MCPD and/or 3-MCPD is reduced by at least 30% by weight, preferably at least 60% by weight, more preferably at least 70% by weight, more preferably at least 80% by weight, more preferably at least 90% by weight, more preferably at least 95% by weight, more preferably at least 98% by weight, most preferably at least 99 or even 99.9% by weight, after step b) when compared to the amount of 2-MCPD and/or 3-MCPD present in the vegetable oil after step a).

In principle it is desirable to remove 2-MCPD and 3-MCPD completely from edible vegetable oils. According to embodiments of the invention, a substantially complete removal of 2-MCPD and 3-MPCD, that is, close to 100% efficiency, is possible according to the inventive process, with excellent yields meaning no substantial loss of oil.

Depending on the amount of 2-MCPD and 3-MCPD in the oil after refining (step a), it may be sufficient to remove less than approximately all of the MCPD-compounds, such as for example a reduction of about 50%. In practice, the process of the present invention can be adjusted to a broad range of removal efficiencies, depending on the use of the final oil, process costs of the vacuum distillation, available equipment for vacuum distillation and the like.

Even a reduction of 2-MCPD and 3-MCPD of for example 40% after step b) when compared to the amount present after step a) may be of interest and is hardly consistently available with the approach in the prior art of optimizing the refining steps.

It has been found by the present inventor that essentially all of the removed MCPD-compounds can be re-found in the distillate, confirming that these compounds are actually removed in the process and not just chemically altered or just present in the oil in a different form.

In an embodiment of the invention the amount of glycidyl esters is reduced by at least 30% by weight, preferably at least 80% by weight, more preferably at least 90% by weight, more preferably at least 95% by weight, more preferably at least 98% by weight, most preferably at least 99 or even 99.9% by weight after step b) when compared to the amount of glycidyl esters present in the vegetable oil after step a).

In principle it is desirable to remove glycidyl esters completely from edible vegetable oils. According to embodiments of the invention, a substantially complete removal of glycidyl esters, that is, close to 100% efficiency is possible according to the inventive process, with excellent yields meaning no substantial loss of oil.

Depending on the amount of glycidyl esters in the oil after refining (step a), it may be sufficient to remove less than approximately all of the glycidyl esters, such as for example a reduction of about 50%. In practice, the process of the present invention can be adjusted to a broad range of removal efficiencies, depending on the use of the final oil, process costs of the vacuum distillation, available equipment for vacuum distillation and the like.

Even a reduction of glycidyl esters of for example 45% after step b) when compared to the amount present after step a) may be of interest and is hardly consistently available with the approach in the prior art of optimizing the refining steps.

It has been found by the present inventor that essentially all of the removed 2-MCPD, 3-MCPD, esters thereof and glycidyl ester compounds can be re-found in the distillate, confirming that these compounds are actually removed in the process and not just chemically altered or just present in the oil in a different form.

Suitable methods of measuring 2-MCPD esters, 3-MCPD esters and glycidyl esters are for example a method named “3 in 1 method” quantifying glycidylester as free glycidol, free 2-MCPD+2-MCPD-ester as free 2-MCPD and free 3-MCPD+3-MCPD-ester as free 3-MCPD. This method is performed by for example SGS Germany GmbH Laboratory Services (Hamburg, Weidenbaumweg 137, DE-21035 Hamburg, Germany).

The process of the present invention is applicable to a variety of vegetable oils. For the time being, most interesting are those commercially significant oils having a tendency to form comparatively high amounts of 2-MCPD, 3-MCPD, esters thereof and glycidyl ester compounds. Such oils are related to palm oil. Palm oil, fractions of palm oil or blends of palm oil and/or its fractions may advantageously be used in the invention.

Oils derived from palm include palm oil, palm oil stearin, palm olein, palm kernel oil, palm kernel stearin, palm kernel olein, coconut oil, coconut stearin, coconut olein and mixtures thereof.

Nevertheless, it may be proven advantageous from a health perspective to subject vegetable oils with only little tendency to form 2-MCPD, 3-MCPD, esters thereof and glycidyl ester compounds during refining to the process of the present invention, because even very small concentrations of 2-MCPD, 3-MCPD, esters thereof and glycidyl ester compounds may not be tolerable in some applications.

In an embodiment of the invention the vegetable oil is selected from the group consisting of coconut oil, palm kernel oil, sunflower oil, soybean oil, rapeseed oil, palm oil, olive oil, avocado oil, corn oil, ground nut oil, shea oil, cocoa butter, safflower oil, sal oil, and illippe oil.

The vegetable oil is typically edible oil. The tendency of native oils to form 2-MCPD, 3-MCPD, esters thereof and glycidyl ester compounds during refining varies widely. Preferably, the vegetable oil comprises or is palm oil. Palm oil, fractions of palm oil or blends of palm oil and/or its fractions may advantageously be used in the invention.

Oils derived from palm include palm oil, palm oil stearin, palm olein, palm kernel oil, palm kernel stearin, palm kernel olein, coconut oil, coconut stearin, coconut olein and mixtures thereof.

In an embodiment of the invention step a) comprises deodorization at a temperature between 180 and 270° C. and a pressure between 0.5-8 mbar.

A deodorization may be run prior to molecular distillation, for example to remove color, odor and other impurities. Deodorization may be most efficient at higher temperatures, such as 260° C. Glycidyl ester formation is at least partly dependent on temperature and is primarily formed at higher temperatures. 2-MCPD and 3-MCPD are formed also at lower temperature, such as at 190° C. According to embodiments of the invention, the deodorization may be run at the optimum conditions with respect to temperature and pressure to obtain the most valuable product, because there is no need to compromise the deodorization conditions to lessen the formation of 2-MCPD, 3-MCPD, esters thereof and glycidyl ester compounds. These are largely taken care of in step b).

In further embodiments of the invention the deodorization conditions are chosen based on desired deodorization efficiency and product value, yield etc.

In an embodiment of the invention said vacuum distillation is a molecular distillation such as short path distillation (SPD).

It is particularly advantageous according to embodiments of the invention to apply molecular distillation, for example in the form of a short path distillation.

It has surprisingly been found that while 2-MCPD, 3-MCPD, esters thereof and glycidyl ester compounds are formed during deodorization, they are effectively reduced in amount by molecular distillation. At the comparatively lower pressures used in short path distillation when compared to deodorization, the absence of water/steam, and most importantly, the short process time, effective removal of 2-MCPD, 3-MCPD, esters thereof and glycidyl ester compounds is possible without the formation of new undesirable compounds or even new 2-MCPD, 3-MCPD, esters thereof and glycidyl ester compounds replenishing those which are distilled of.

At the same time the triglyceride composition of the oil is not altered during molecular distillation and the amount of oil lost to the distillate is negligible for practical purposes making the process extremely effective for removal of 2-MCPD, 3-MCPD, esters thereof and glycidyl ester compounds.

Further, the small amounts of oil lost to the distillate together with the removed 2-MCPD, 3-MCPD, esters thereof and glycidyl ester compounds may be burned in an oven and provide heating useful in the oil refining process.

In an embodiment of the invention wherein the refining steps according to step a) produce 3-MCPD and/or glycidyl esters within the vegetable oil, and the combined concentration of 3-MCPD and glycidyl esters is at least 1 mg/kg.

Even very small amounts of 3-MCPD and glycidyl esters may be problematic in edible oil due to the concerns regarding the supposed toxicity and even carcinogenetic and genotoxic properties of these compounds. Even in vegetable oils comprising only about 1 ppm of combined 3-MCPD and glycidyl esters, the process according to embodiments of the invention may be advantageously applied to reduce the amount of these undesirable substances.

The higher the combined concentrations of 3-MCPD and glycidyl esters present after step a) the greater the need for step b).

In an embodiment of the invention the vacuum distillation process of step b) is a short path distillation and the residence time of the oil in step b) is below 10 minutes, preferably below 5 minutes, more preferably below 3 minutes.

It has surprisingly been found that only short residence times in the short path distillation are necessary to achieve substantial reductions in the amount of MCPD-compounds. In this way, the time during which the oil is in contact with the hot evaporator surface can be minimized and equipment cost can be lower due to more compact dimensions of the distillation apparatus. No special designs are necessary to obtain the substantial reduction in the amount of 2-MCPD, 3-MCPD, esters thereof and glycidyl ester compounds of the process of the present invention.

A second aspect of the invention relates to a vegetable oil treated by the process according to any of its embodiments.

A vegetable oil treated according to embodiments of the invention has exceptional quality with respect to the low concentration of 2-MCPD, 3-MCPD, esters thereof and glycidyl ester compounds.

A third aspect of the invention relates to the use of the vegetable oil of the second aspect of the invention or the vegetable oil treated by the process according to the first aspect of the invention in an edible food product.

The vegetable oil treated according to embodiments of the invention may be used for food applications. Especially for infant formulas, toddlers formulas, as well as elderly formulas, vegetable oils with little or substantially no content of 2-MCPD, 3-MCPD, esters thereof and glycidyl ester compounds are of high value.

Thus, in a further aspect, uses of said vegetable oil in all its embodiments herein and produced in all mitigation processes herein in an edible food product is wherein said product is a product targeting specific sub-populations, such as nutrition products e.g. products targeting infants and toddlers, or products targeting elderly or other sub-populations with specific, nutritional needs.

In further embodiments of the invention uses of said vegetable oil in all its embodiments herein and produced in all mitigation processes herein in an edible food product is wherein said edible food product is a nutrition product, such as an infant nutrition product, a toddler nutrition product, or an elderly nutrition product.

A fourth aspect of the invention relates to an edible food product according to the third aspect of the invention, e.g. a nutrition product, such as an infant nutrition product, a toddler nutrition product, or an elderly nutrition product.

The process according to embodiments of the invention provides vegetable oil usable in a variety of edible food products. The nutritional value of these edible food products is enhanced by the reduction or removal of 2-MCPD, 3-MCPD, esters thereof and glycidyl esters compounds from the vegetable oil used in such products.

In an embodiment of the invention the edible food product according to the edible food product of the fourth aspect of the invention is e.g. a nutrition product, such as an infant nutrition product, a toddler nutrition product, or an elderly nutrition product.

### EXAMPLES

Non-limiting examples which embody certain aspects of the invention will now be described.

### Example 1

Six samples of RBD PO (refined, bleached, and deodorized palm oil) with an average weight of approximately 1,550 g each were one by one treated in a laboratory short-path-distillation plant type KDL 5 from UIC GmbH, Alzenau-Hörstein, at different temperatures and pressures in order to study whether the content of 2-MCPD, 3-MCPD and glycidol in the RBD PO sample could be reduced at the chosen temperatures and pressures.

2-MCPD esters, 3-MCPD esters and glycidyl esters are all measured using methods to quantify glycidylester as free glycidol, free 2-MCPD+2-MCPD-ester as free 2-MCPD and free 3-MCPD+3-MCPD-ester as free 3-MCPD. They were all analyzed by SGS Germany GmbH Laboratory Services Hamburg, Weidenbaumweg 137, DE-21035 Hamburg, Germany, according to their standard method: “3 in 1 method”.

| Set point | Actual | Set point | Actual | | | |
|---|---|---|---|---|---|---|
| temperature | temperature | pressure | pressure | 3-MCPD | 2-MCPD | Glycidol |
| ° C. | ° C. | mBar | mBar | mg/kg | mg/kg | mg/kg |
| Start values, RBD PO sample | | | | 4.95 | 2.83 | 4.65 |
| 230 | 230 | 0.1 | 0.0875 | 4.07 | 2.50 | 0.82 |
| 230 | 230 | 1.0 | 1.15 | 4.69 | 2.79 | 1.49 |
| 245 | 245 | 0.5 | 0.50 | 4.34 | 2.62 | 1.29 |
| 260 | 260 | 0.1 | 0.052 | 2.38 | 1.48 | 0.56 |
| 260 | 260 | 1.0 | 1.25 | 4.35 | 2.61 | 1.03 |
| 260 | 260 | 2.0 | 2.35 | 4.50 | 2.71 | 1.43 |

The results show clearly that the higher the temperature and the lower the pressure, the lower is the final concentration of 2-MCPD, 3-MCPD, and glycidol.

### Example 2

1 537.0 g of RBD PO with an initial content of 2.83 mg/kg 2-MCPD, 4.95 mg/kg 3-MCPD and 4.65 mg/kg glycidol was treated in a laboratory short-path-distillation plant type KDL 5 from UIC GmbH, Alzenau-Hörstein, at 260° C., 0.052 mBar and at an average flow rate of 12.5 mL/minute in order to study whether 2-MCPD, 3-MCPD, and glycidol would be formed during the high temperature treatment. During the distillation 64.1 g distillate and 1,472.9 g residue was produced. The concentration of 2-MCPD, 3-MCPD, and glycidol in residue and distillate was:

| | Residue | Distillate |
|---|---|---|
| | mg/kg | mg/kg |
| 3-MCPD | 0.56 | 95.4 |
| 2-MCPD | 1.48 | 32.3 |
| Glycidol | 2.38 | 62.5 |

2-MCPD esters, 3-MCPD esters and glycidylesters are all measured using methods to quantify glycidylester as free glycidol, free 2-MCPD+2-MCPD-ester as free 2-MCPD and free 3-MCPD+3-MCPD-ester as free 3-MCPD. They were all analyzed by SGS Germany GmbH Laboratory Services Hamburg, Weidenbaumweg 137, DE-21035 Hamburg, Germany, according to their standard method: “3 in 1 method”.

Calculating the comparable start concentrations of 2-MCPD, 3-MCPD and glycidol in RBD PO runs thus:

| | | | | | | Deviation |
|---|---|---|---|---|---|---|
| | | | | | Start values | between |
| | | | | Calculated | RBD PO | calc. conc. |
| | Residue | Distillate | In all | concentration | sample | and start |
| | mg | mg | mg | mg/kg | mg/kg | values |
| 3-MCPD | 3.51 | 4.01 | 7.51 | 4.89 | 4.95 | 1.3% |
| 2-MCPD | 2.18 | 2.07 | 4.25 | 2.77 | 2.83 | 2.3% |
| Glycidol | 0.82 | 6.12 | 6.94 | 4.52 | 4.65 | 2.9% |

The result shows clearly that neither 2-MCPD, 3-MCPD nor glycidol are formed during the high temperature treatment.

### FIGURE REFERENCES

FORM—Formation of MCPD and glycidol
CPO—Crude palm oil
NBDR—NBD refining
RBDR—RBD refining
NBDPO—NBD palm oil
RBDPO—RBD palm oil
DH—Degassing and heating
VD—Vacuum distillation
FRPO—Fully refined palm oil
REM—Removal of MCPD and glycidol

1. A process for the removal of 2-monochloropropane-1,3-diol, 3-monochloropropane-1,2-diol, and esters and glycidyl esters thereof in vegetable oil comprising:
a) subjecting the vegetable oil to at least one refining step, wherein the at least one refining step is a deodorization and is at a temperature equal to or greater than about 230° C.;
and
b) subjecting the refined vegetable oil from step a) to a vacuum distillation at about 200-280° C. and at a pressure of about 0.001-3.0 mbar.

2. The process according to claim 1, wherein the at least one refining step of a) further comprises performing at least one additional step chosen from de-gumming, bleaching, and deacidification.

3. The process according to claim 1, wherein the vacuum distillation is performed at a temperature between about 220-270° C.

4. The process according to claim 1, wherein the vacuum distillation is performed at a pressure of 0.002-2.5 mbar.

5. The process according to claim 1, wherein the amount of 2-monochloropropane-1,3-diol and/or 3-monochloropropane-1,2-diol is reduced by at least 30% by weight, after step b) when compared to the amount of 2-monochloropropane-1,3-diol and/or 3-monochloropropane-1,2-diol present in the vegetable oil after step a).

6. The process according to claim 1, wherein the amount of glycidyl esters is reduced by at least 30% by weight, after step b) when compared to the amount of glycidyl esters present in the vegetable oil after step a).

7. The process according to claim 1, wherein the vegetable oil is chosen from coconut oil, palm kernel oil, sunflower oil, soybean oil, rapeseed oil, palm oil, olive oil, avocado oil, corn oil, ground nut oil, shea oil, cocoa butter, safflower oil, sal oil, and illippe oil.

8. The process according to claim 1, wherein the deodorization is at a temperature between 180 and 270° C. and a pressure between 0.5-8 mbar.

9. The process according to claim 1, wherein said vacuum distillation is a molecular distillation.

10. The process according to claim 1, wherein the at least one refining step of step a) produces 3-monochloropropane-1,2-diol and/or glycidyl esters thereof within the vegetable oil, and wherein the combined concentration of 3-monochloropropane-1,2-diol and glycidyl esters thereof is at least 1 mg/kg.

11. The process according to claim 1, wherein the vacuum distillation process of step b) is a short path distillation and the residence time of the oil in step b) is below 10 minutes.

12. The process according to claim 1, wherein the vacuum distillation is performed at a temperature between about 230-260° C.

13. The process according to claim 1, wherein the vacuum distillation is performed at a pressure of 0.005-2.0 mbar.

14. The process according to claim 1, wherein the vacuum distillation is performed at a pressure of 0.005-1.5 mbar.

15. The process according to claim 1, wherein the amount of 2-monochloropropane-1,3-diol and/or 3-monochloropropane-1,2-diol is reduced by at at least 60% by weight, after step b) when compared to the amount of 2-monochloropropane-1,3-diol and/or 3-monochloropropane-1,2-diol present in the vegetable oil after step a).

16. The process according to claim 1, wherein the amount of 2-monochloropropane-1,3-diol and/or 3-monochloropropane-1,2-diol is reduced by at least 70% by weight after step b) when compared to the amount of 2-monochloropropane-1,3-diol and/or 3-monochloropropane-1,2-diol present in the vegetable oil after step a).

17. The process according to claim 1, wherein the amount of glycidyl esters is reduced by at least 80% by weight after step b) when compared to the amount of glycidyl esters present in the vegetable oil after step a).

18. The process according to claim 9, wherein said vacuum distillation is a short path distillation.

19. The process according to claim 1, wherein the vacuum distillation process of step b) is a short path distillation and the residence time of the oil in step b) is below 5 minutes.

20. The process according to claim 1, wherein the vacuum distillation process of step b) is a short path distillation and the residence time of the oil in step b) is below 3 minutes.
